(19) United States
(12) Patent Application Publication
(10) Pub. No.: US 2024/0354366 A1
(43) Pub. Date: Oct. 24, 2024

(54) SYSTEMS AND METHODS FOR SOLVING ORDINARY DIFFERENTIAL EQUATIONS USING A SINGLE-INPUT MULTIPLE DATA (SIMD) PROCESSOR

(71) Applicant: JuliaHub, Inc., Boston, MA (US)

(72) Inventors: Yingbo Ma, Newton, MA (US); Christopher Rackauckas, Cambridge, MA (US)

(21) Appl. No.: 18/612,230

(22) Filed: Mar. 21, 2024

Related U.S. Application Data
(60) Provisional application No. 63/491,418, filed on Mar. 21, 2023.

(51) Int. Cl. G06F 17/13

(52) U.S. Cl. CPC G06F 17/13

(57) ABSTRACT

Disclosed herein are systems and methods that take advantage of SIMD processor architecture to efficiently simulate continuous systems whose laws are defined by ordinary differential equations. Solving of ordinary differential equations is accelerated by optimizing properties of a tableau of numbers and using them for simultaneous or parallel processing by a single-input multiple data (SIMD) processor. Numerous calculations, such as Runge-Kutta calculations, are loaded and executed in parallel in a large register of a SIMD processor. These parallel calculations have a sparsity pattern that allows for parallel calculation. The multiple parallel calculations provide faster and more accurate solving of ordinary differential equations.

### CROSS-REFERENCE TO RELATED APPLICATIONS

This application claims the benefit of priority of U.S. Provisional Patent Application No. 63/491,418, entitled “SYSTEMS AND METHODS FOR SOLVING ORDINARY DIFFERENTIAL EQUATIONS USING A SINGLE-INPUT MULTIPLE DATA (SIMD) PROCESSOR,” filed by JuliaHub, Inc., on Mar. 21, 2023, the entire contents of which is incorporated by reference herein.

### TECHNICAL FIELD

The field of the invention relates generally to systems and methods that take advantage of processor architecture to efficiently simulate continuous systems whose laws are defined by ordinary differential equations, such as physical systems, mechanical systems, biological systems, chemical systems, and the like. More specifically, the invention relates to systems and methods for accelerated solving of ordinary differential equations by optimizing properties of a tableau of numbers and using them for simultaneous or parallel processing by a single-input multiple data (SIMD) processor.

### BACKGROUND

Ordinary differential equations (ODEs) are differential equations containing one or more functions of one independent variable and the derivatives of those functions. ODEs arise in many contexts and, therefore, their solution is also desirable in many contexts.

Various systems exist for solving ODEs, often referred to as ODE solvers, which use various numerical or mathematical methods for solving ODEs executed by a general-purpose computer processor. While it is desirable for an ODE solver to be fast, efficient, stable, and accurate, these goals must often be balanced.

Some ODE solvers use tableau-based methods, such as traditional Runge-Kutta (“RK”) methods, for solving differential equations. Runge-Kutta methods are a family of numerical methods, each with trade-offs between efficiency, accuracy, stability, etc. For example, Euler's method is a Runge-Kutta method that is conceptually simple but inefficient, while the fourth-order Runge-Kutta method (“RK4”) is more complicated but more efficient.

All RK methods have a common form that can be summarized by a matrix and two vectors. This summary of an RK method is known as a Butcher tableau. One way that conventional ODE solvers have improved is by finding a tableau of numbers that have properties that are advantageous to within-method parallelism. Such properties include high-order, low-truncation errors, good stability, etc. Within-method parallelism includes calculating multiple equations simultaneously, which is possible when the sparsity pattern indicates that more than one operation can be performed without depending on the result of another operation. ODE solvers, therefore, may determine whether a tableau has these sparsity patterns and, if so, can achieve structures that allow for parallelism in the RK method.

One problem, however, is that even when solving multiple equations using within-method parallelism, conventional CPU architectures do not fully take advantage of the sparsity patterns and structures that allow for parallelism in the RK method.

Conventional CPU architectures execute instruction streams to perform operations on data stored in a single memory. This includes both single instruction stream, single data stream (SISD), where a single processor executes a single instruction stream, and multiple instruction stream, single data (MISD), where many functional or processing units perform different operations on the same data stored in a single memory.

Accordingly, there is a need for improved systems and methods for solving ODEs using a SIMD processor that takes fuller advantage of the sparsity patterns and structures that allow for parallelism in the Runge-Kutta method.

### SUMMARY

Disclosed herein are systems and methods for solving ordinary differential equations using a SIMD processor. Compared to known methods of solving ordinary differential equations, the systems and methods described herein take advantage of the known register size of the SIMD processor to run specifically tuned calculations that use the register to run multiple calculations in parallel.

The systems and methods described herein exploit various specific hardware architectures to provide significantly accelerated solving of ordinary differential equations. This provides a practical advantage in that it allows for efficient parallel processing to determine more accurate solutions to ordinary differential equations at highly accelerated rates, as shown by the results described below.

In an embodiment, a system for solving a user-provided function using multiple parallel calculations of an ordinary differential equation solver is disclosed. The system includes a compiler and a SIMD hardware processor architecture. The SIMD hardware processor architecture includes a register having a specific register size, and a vector processing unit. The compiler is configured for receiving a user-provided function. The compiler is further configured for transforming each intrinsic operation in the user-provided function to a SIMD-compatible operation, such that each intrinsic operation can be calculated at multiple points simultaneously. The vector processing unit is configured for solving an ordinary differential equation using the transformed intrinsic operations by iteratively solving a set of calculations that represents the ordinary differential equation. The set of calculations comprises multiple stages to be executed. The vector processing unit is further configured for loading a number of parallel values into the register to use for parallel calculations. The number of parallel values loaded into the register is equal to or less than the specific register size divided by a bit size of a floating point representation of the values. The vector processing unit is further configured for executing in parallel a subset of the multiple stages from the set of calculations using a pre-derived tableau of coefficients having a sparsity matrix with a lower triangular pattern that includes at least one zero in the pattern to allow for simultaneous calculation of multiple stages using the parallel values. The number of multiple stages from the set of calculations is equal to the number of parallel values loaded into the register. The at least one zero in the pattern of the sparsity matrix is defined such that each stage in the subset of the multiple stages that is executed in parallel does not rely on another stage in the subset of the multiple stages that is executed in parallel.

In another embodiment, a system for performing multiple parallel calculations of a tableau-based ordinary differential equation solver is disclosed. The system includes a SIMD hardware processor architecture. The SIMD architecture includes a register having a specific register size, and a processor. The processor is configured for solving an ordinary differential equation by iteratively solving a set of calculations that represents the ordinary differential equation. The set of calculations comprises multiple stages to be executed. The processor is further configured for loading a number of parallel values into the register to use for the multiple parallel calculations. The number of parallel values loaded into the register is equal to or less than the specific register size divided by a bit size of a floating point representation of the values. The processor is further configured for executing a subset of the multiple stages from the set of calculations in parallel using a pre-derived tableau of coefficients having a sparsity matrix with a lower triangular pattern that includes at least one zero in the pattern to allow for simultaneous calculation of multiple stages using the parallel values. The number of multiple stages from the set of calculations is equal to the number of parallel values loaded into the register. The at least one zero in the pattern of the sparsity matrix is defined such that each stage in the subset of the multiple stages that is executed in parallel does not rely on another stage in the subset of the multiple stages that is executed in parallel.

In another embodiment, a method for performing multiple parallel calculations of a tableau-based method of solving an ordinary differential equation on a SIMD hardware processor architecture is disclosed. The method includes solving an ordinary differential equation by iteratively solving a set of calculations that represents the ordinary differential equation. The set of calculations comprises multiple stages to be executed. The method further includes loading a number of parallel values into a register of the SIMD hardware processor to use for the multiple parallel calculations. The number of parallel values loaded into the register of the SIMD hardware processor is equal to or less than a size of the register divided by a bit size of a floating point representation of the values. The method further includes executing a subset of the multiple stages from the set of calculations in parallel using a pre-derived tableau of coefficients having a sparsity matrix with a lower triangular pattern that includes at least one zero in the pattern to allow for simultaneous calculation of multiple stages using the parallel values. The number of multiple stages from the set of calculations is equal to the number of parallel values loaded into the register. The at least one zero in the pattern of the sparsity matrix is defined such that each stage in the subset of the multiple stages that is executed in parallel does not rely on another stage in the subset of the multiple stages that is executed in parallel.

In various embodiments, the systems and methods described herein may determine the register size of the register of the SIMD hardware processor using a standard instruction.

In various embodiments of the systems and methods described herein, the intrinsic operations are transformed to the SIMD-compatible operations using Intel SSE instructions. The set of calculations may include 14 calculations, and the subset of multiple stages includes two stages, such that the set of 14 calculations is solved using 7 sets of two stages that are executed in parallel. The vector processing unit may be a CPU or a GPU. The parallel values loaded into the register may be coefficients from the pre-derived tableau of coefficients or intermediate values that are determined during execution of the subset of multiple stages from the set of calculations. The tableau-based method of solving the ordinary differential equation may be a Runge-Kutta method. The register size may be 128 bits and the number of parallel values is two. The register size may be 256 bits and the number of parallel values may be two or four. The register size may be 512 bits, and the number of parallel values may be two, four, or eight.

### BRIEF DESCRIPTION

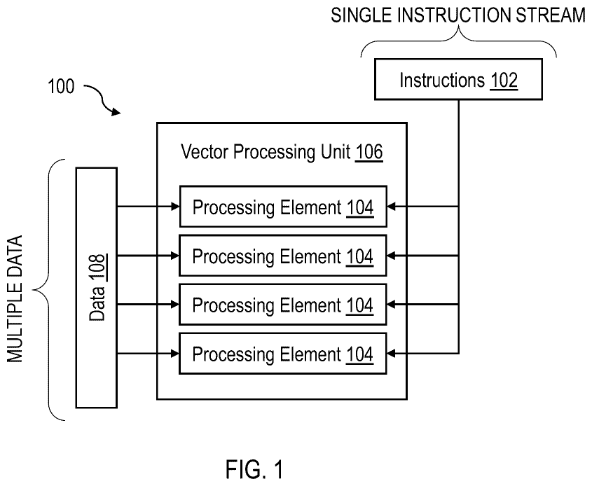

FIG. 1 depicts a block diagram of a modern CPU architecture that allows for single-input multiple data (SIMD) calculations suitable for implementing the subject matter described herein.

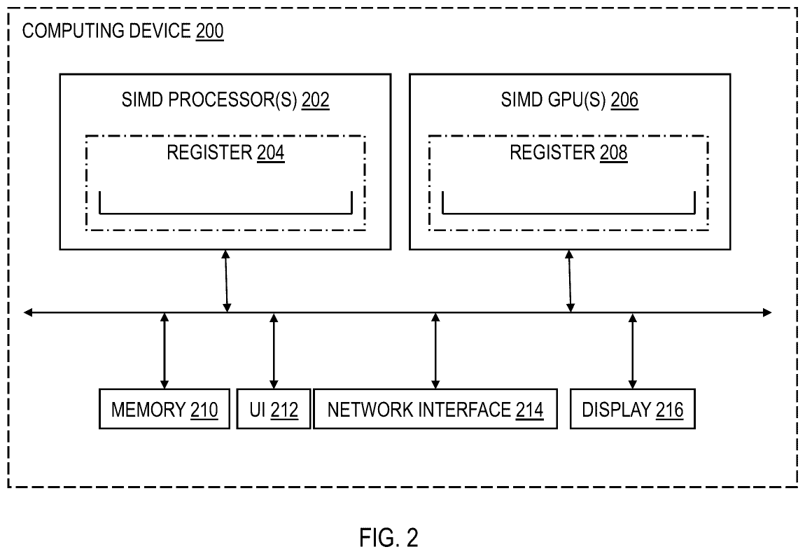

FIG. 2 depicts a block diagram illustrating an embodiment of a computing device that implements the systems and methods described herein.

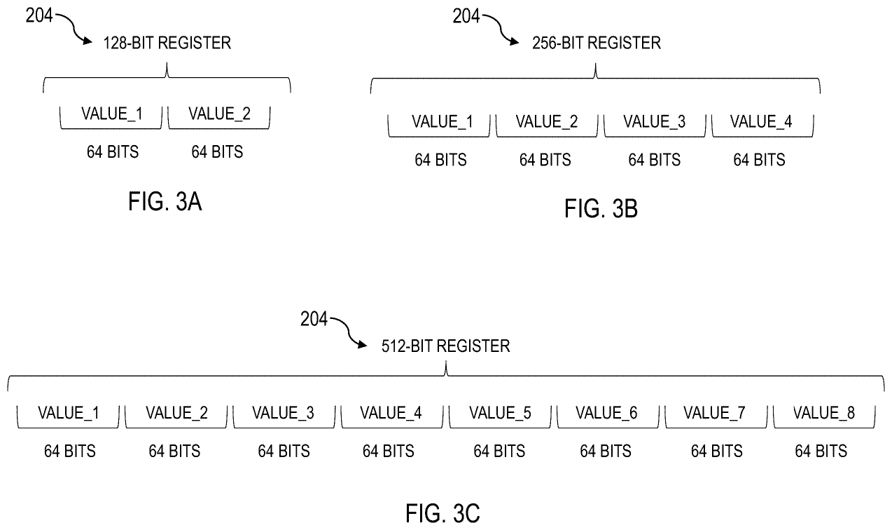

FIG. 3A depicts a 128-bit register in which two 64-bit values are loaded and executed in parallel for processing a modified Runge-Kutta method according to the subject matter described herein.

FIG. 3B depicts a 256-bit register in which up to four 64-bit values are loaded and executed in parallel for processing a modified Runge-Kutta method according to the subject matter described herein.

FIG. 3C depicts a 512-bit register in which up to eight 64-bit values are loaded and executed in parallel for processing a modified Runge-Kutta method according to the subject matter described herein.

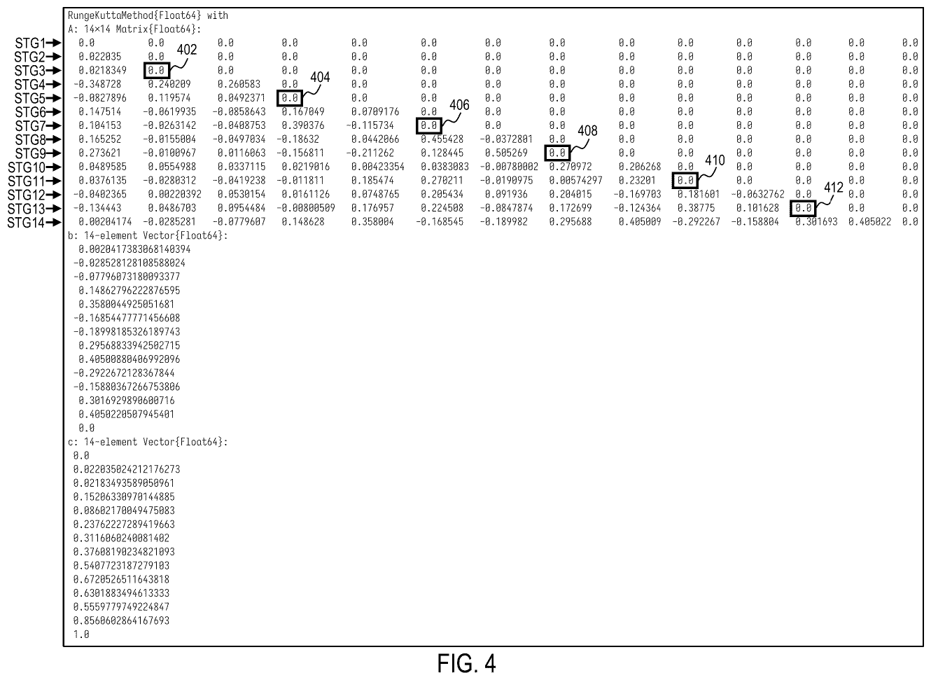

FIG. 4 depicts an exemplary 14×14 tableau for a modified Runge-Kutta method according to the subject matter described herein.

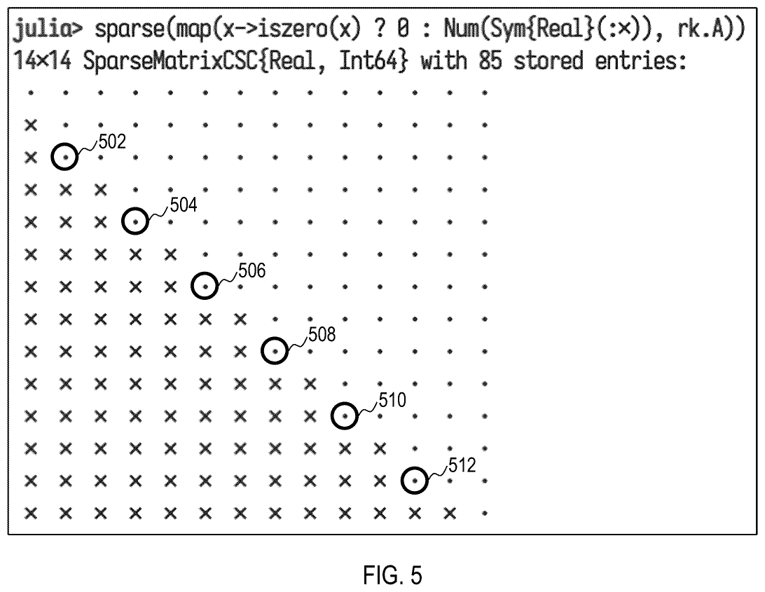

FIG. 5 depicts an exemplary 14×14 sparsity matrix for a modified Runge-Kutta method according to the subject matter described herein.

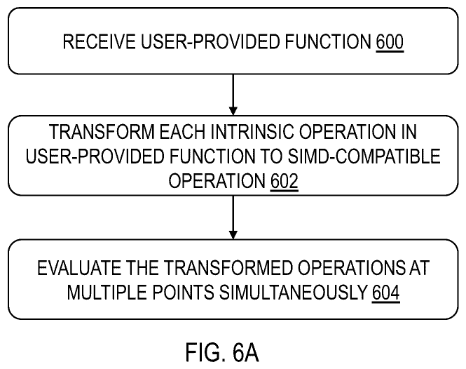

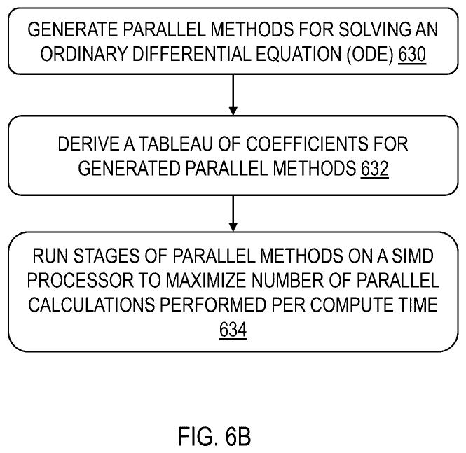

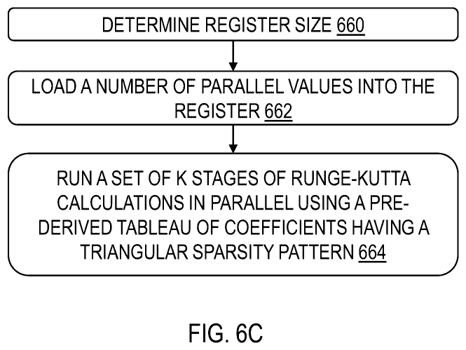

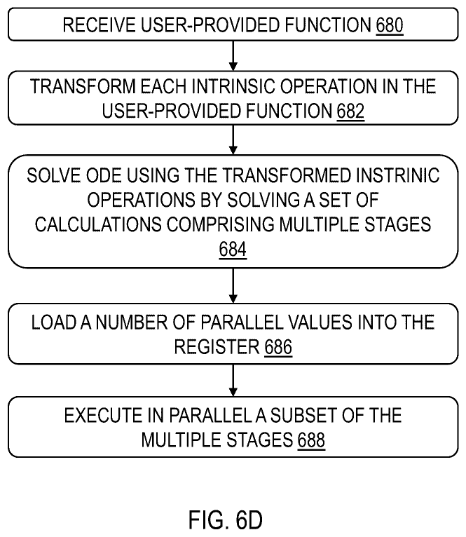

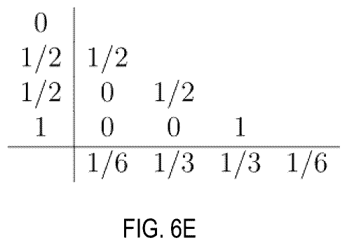

FIG. 6A depicts a flow chart of an exemplary process for converting a user-provided function into SIMD-compatible operations.

FIG. 6B depicts a flow chart of an exemplary process for accelerated solving of ordinary differential equations using Runge-Kutta methods, tuned sparsity patterns, and a SIMD processor architecture according to the subject matter described herein.

FIG. 6C depicts a flow chart of an exemplary process for performing multiple Runge-Kutta calculations in parallel on a SIMD processor architecture according to the subject matter described herein.

FIG. 6D depicts a flow chart of an exemplary process for solving a user-provided function using multiple parallel calculations of an ordinary differential equation solver.

FIG. 6E depicts a tableau of coefficients for a modified Runge-Kutta method according to an embodiment described herein.

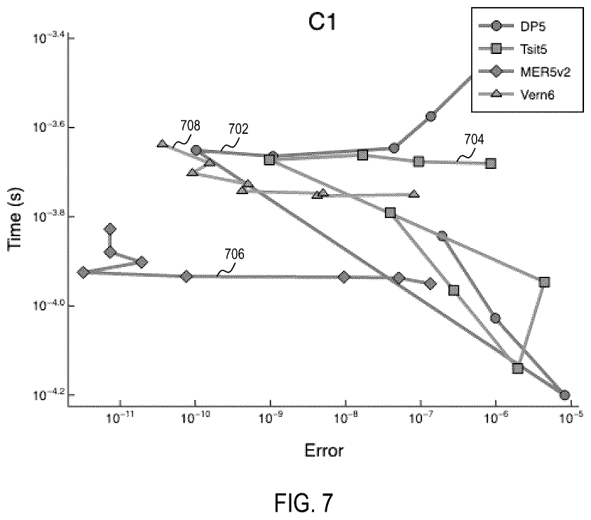

FIG. 7 depicts results C1 from running a first well-known testing problem using the systems and methods described herein, as compared to other known systems and methods for solving ordinary differential equations.

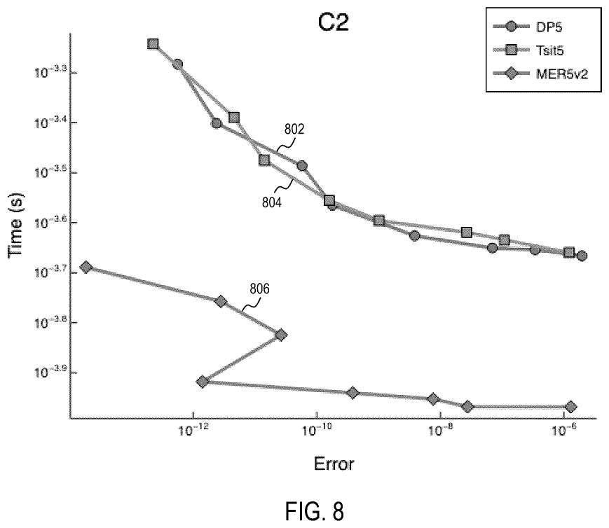

FIG. 8 depicts results C2 from running a second well-known testing problem using the systems and methods described herein, as compared to other known systems and methods for solving ordinary differential equations.

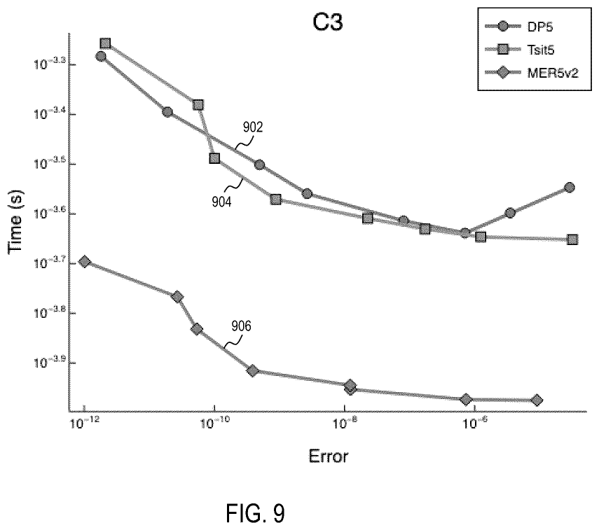

FIG. 9 depicts results C3 from running a third well-known testing problem using the systems and methods described herein, as compared to other known systems and methods for solving ordinary differential equations.

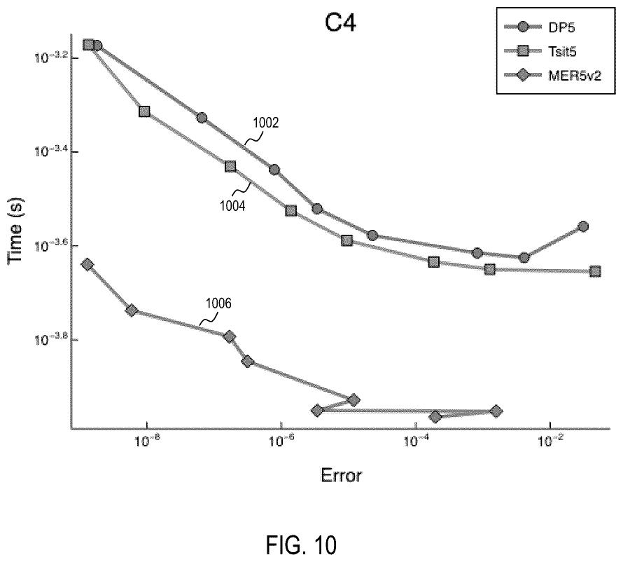

FIG. 10 depicts results C4 from running a fourth well-known testing problem using the systems and methods described herein, as compared to other known systems and methods for solving ordinary differential equations.

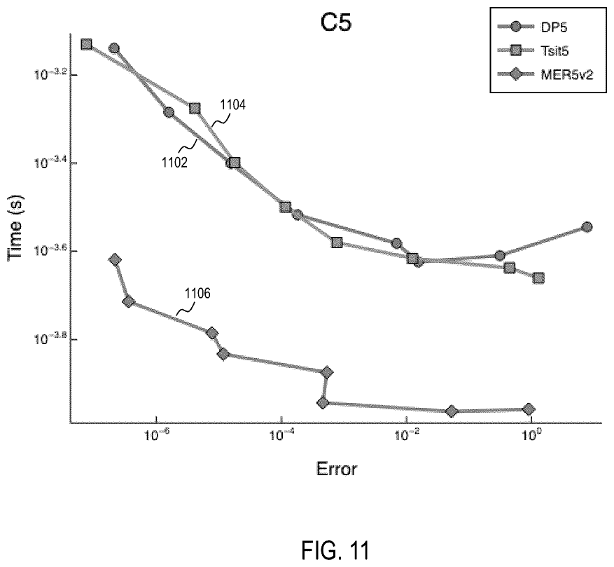

FIG. 11 depicts results C5 from running a fifth well-known testing problem using the systems and methods described herein, as compared to other known systems and methods for solving ordinary differential equations.

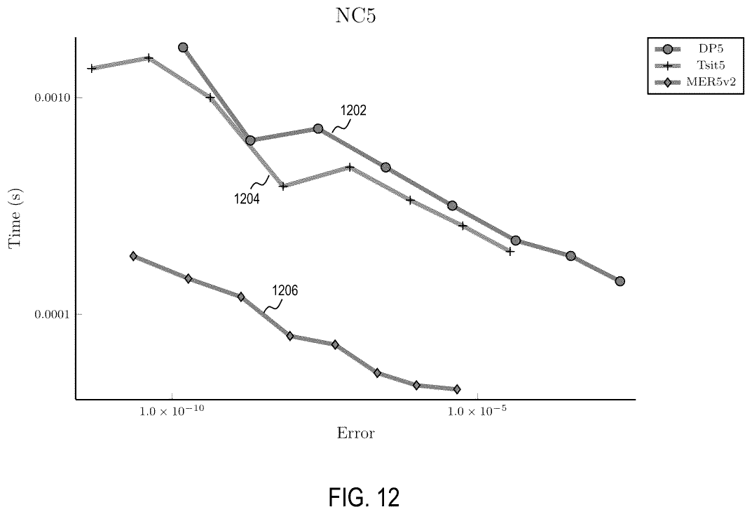

FIG. 12 depicts results NC5 from running a sixth well-known testing problem using the systems and methods described herein, as compared to other known systems and methods for solving ordinary differential equations.

### DETAILED DESCRIPTION

This summary is provided to introduce a selection of concepts in a simplified form that are further described below in the detailed description. This summary is not intended to identify key features or essential features of the claimed subject matter, nor is it intended to be used to limit the scope of the claimed subject matter.

The subject matter described herein provides novel advantages over existing technology through a combination of determining and using a specific sparsity pattern with a new mathematical method that exploits the existing register of a single instruction, multiple data (SIMD) processor. By using modified methods, such as Runge-Kutta methods, with a specific type of parallel sparsity pattern, software instructions can be generated that perform multiple calculations at the same time via the existing SIMD registers.

Modern central processing units (CPUs) or graphics processing units (GPUs) (or processors) perform parallel processing, which allows for multiple computations to be carried out simultaneously, in parallel. Parallel processing may be achieved using two different techniques: (1) single instruction, multiple data (SIMD); and (2) multiple instruction, multiple data (MIMD). In SIMD, each processing unit performs the same instruction (i.e., single instruction) at a given time but with different data (i.e., multiple data). In MIMD, each processing unit performs a different instruction (i.e., multiple instruction) at a given time using different data (i.e., multiple data).

FIG. 1 depicts a block diagram of a modern CPU architecture that allows for single-input multiple data (SIMD) calculations suitable for implementing the subject matter described herein. Referring to FIG. 1, SIMD architecture 100 is shown. In the SIMD architecture 100, data pool 108 provides different data to multiple processing elements 104 of vector processing unit 106. The processing elements 104 all run the same instruction from the instruction pool 102, using different values provided by data pool 108.

FIG. 2 depicts a block diagram illustrating one embodiment of a computing device for the systems and methods described herein. Referring to FIG. 2, the computing device 200 may include at least one SIMD processor 202, at least one graphical processing unit (“GPU”) 206, a memory 210, a user interface (“UI”) 212, a network interface 214, and/or a display 216. As shown, for example, in FIG. 2, SIMD processor 202 includes a register 204. The memory 210 may be partially integrated with the processor(s) 202 and/or the GPU(s) 206. The UI 212 may include a keyboard and a mouse. The UI 212 and the display 216 may provide any of the GUIs in the embodiments of this disclosure. In some embodiments, GPU 206 may comprise a SIMD architecture, similar to the SIMD architecture described herein in the context of processors. GPU 206 includes register 208. In various embodiments, register 204 and/or register 208 may be 128-bit, 256-bit, 512-bit, or 1024-bit registers.

Modern processors, such as SIMD processor 202 and/or GPU 206 depicted in FIG. 2, include floating-point registers for performing calculations. As one example, some modern processors use an ×86 instruction set architecture. Streaming SIMD Extensions (SSE) and Advanced Vector Extensions (AVX) are extensions to the ×86 instruction set architecture for Intel® and Advanced Micro Devices (AMD®) processors. There are various versions, for example AVX, expands many floating point instructions to 256 bits, and AVX-512, which both expands instructions to 512 bits, adds many new instructions, and extends support of older instructions to more data types. Thus, processors that can handle AVX extensions necessarily include registers of the size allowed by the AVX instruction size. Among current commercially available designs, these registers may be 128 bits, 256 bits, or 512 bits in length. Larger registers are possible in the future. Another consideration are scalable vector extensions, such as ARM's Scalable Vector Extensions (SVE) and SVE2, or RISC-V′s RISC-V Vector Extension (RVV). These registers are not of fixed size with respect to the Instruction Set Architecture (ISA), but are of fixed size within an implementation. These instruction sets include instructions to query vector size of the implementation, and thus when referring to fixed size vectors herein, it may be assumed to generalize to these scalable vector implementations. As another example, some GPUs are SIMD chips that have different names and bit sizes for the vector extensions. The subject matter described herein uses these modern processor architectures that include large floating-point registers that allow for SIMD calculations. The embodiments described herein are described in the context of systems and methods for ODE solvers using these SIMD architectures to do so more efficiently than can traditionally be accomplished. In the embodiments described herein, the ODE solvers use modified Runge-Kutta methods for solving ODEs. However, it will be understood that Runge-Kutta methods are just one set of methods for which the systems and methods described herein may be applied. Any tableau-based method may be applied, such as (but not limited to) general linear methods, Rosenbrock methods, implicit Runge-Kutta methods, exponential integrators, and the like.

When performing a Runge-Kutta method, for example, multiple calculations are performed using coefficients that are stored in a tableau. These coefficients are derived and/or optimized for use with the particular Runge-Kutta method being performed. These coefficients are generally 64-bit floating point numbers, which are each 64 bits in length. Therefore, a 128-bit register can hold and execute up to two 64-bit values at the same time, a 256-bit register can hold and execute up to four 64-bit values at the same time, and a 512-bit register can hold and execute up to eight 64-bit values at the same time.

Consider an example scenario in which two separate calculations are performed as part of a Runge-Kutta method. These two separate calculations are x1*y1 (Operation 1) and x2*y2 (Operation 2). These two multiplication operations can be performed by modern SIMD processor hardware in parallel or simultaneously such that both multiplications are evaluated at the same time. In this case, x1, x2, y1, and y2 are all loaded into a register, and the multiplication operation is performed in parallel for each operation. Some CPUs and graphics processing units (GPUs) have SIMD registers of 256 and 512 bits to run many multiplications, additions, and other operations simultaneously. By taking advantage of these large SIMD registers, the subject matter described herein provides significant performance gains when solving ODEs using Runge-Kutta methods.

In traditional Runge-Kutta methods, each subsequent calculation relies on the result from the previous calculation. This means that each calculation must be performed in series, since the next calculation cannot be performed until the current calculation has completed. For CPUs or GPUs having SIMD registers of a particular fixed size (e.g., 128, 256, 512 bits, etc.), parallel Runge-Kutta methods can be generated that are tuned specifically for each specific processor with a particular SIMD register. This allows the processor to run multiple k calculations at the same time without requiring any extra compute time. Each of the k calculations that are run at the same time must not depend on any of the other k calculations. Because the processor can generate more k calculations, better properties for tableaus of numbers are obtained for each processor because there are more numbers to tune. For example, the subject matter described herein may use two, four, or eight times as many numbers for tuning within the same compute time as compared with conventional Runge-Kutta methods. By exploiting the SIMD registers, the systems and methods described herein have been shown to result in five to ten times faster solving of some ODEs using Runge-Kutta methods.

Specific calculations for a Runge-Kutta method can be derived that are matched to the size of the registers in the processor on which the calculations for the Runge-Kutta method will be performed. As explained above, these calculations are structured such that no calculation in a set of parallel calculations relies on any other calculation in that set of calculations. This structure for the calculations results in a tableau having a triangular sparsity pattern, as described in more detail below.

Conversely, it is appreciated that when the SIMD registers are mismatched to the number of k calculations, the sparsity pattern provides worse results than not having the sparsity pattern or using standard methods with conventional (SISD or MISD) processors.

FIG. 3A depicts a 128-bit register in which two 64-bit values are loaded and executed in parallel for processing a modified Runge-Kutta method according to the subject matter described herein.

FIG. 3B depicts a 256-bit register in which up to four 64-bit values are loaded and executed in parallel for processing a modified Runge-Kutta method according to the subject matter described herein.

FIG. 3C depicts a 512-bit register in which up to eight 64-bit values are loaded and executed in parallel for processing a modified Runge-Kutta method according to the subject matter described herein.

FIG. 4 depicts an exemplary 14×14 tableau for a modified Runge-Kutta method according to the subject matter described herein. As can be seen from FIG. 4, the exemplary tableau has a triangular sparsity pattern with extra zeroes 402, 404, 406, 408, 410, and 412, which allow for stages k and k+1 to be computed simultaneously for even stages k. The tableau indicates that the Runge-Kutta method includes 14 stages, as shown in FIG. 4. The extra zeroes in the tableau show that stages 2 and 3 can be calculated simultaneously (as a result of zero 402), stages 4 and 5 can be calculated simultaneously (as a result of zero 404), stages 6 and 7 can be calculated simultaneously (as a result of zero 406), stages 8 and 9 can be calculated simultaneously (as a result of zero 408), stages 10 and 11 can be calculated simultaneously (as a result of zero 410), and stages 12 and 13 can be calculated simultaneously (as a result of zero 412).

Table 2, below, shows a listing of the values of the tableau shown in FIG. 4.

TABLE 2

| | A: 14 × 14 Array{Float64, 2}: | | |
|---|---|---|---|
| a21 | 0.022035024212176273 | a137 | −0.08478741516544007 |
| a31 | 0.02183493589050961 | a138 | 0.17269907813077384 |
| a41 | −0.34872816866757517 | a139 | −0.12436417901182058 |
| a42 | 0.24020895942224316 | a1310 | 0.3877495277324938 |
| a43 | 0.26058251894678086 | a1311 | 0.10162786957452331 |
| a51 | −0.08278958817912686 | a141 | 0.0020417383068140394 |
| a52 | 0.11957422836029977 | a142 | −0.028528128108588024 |
| a53 | 0.04923706031357792 | a143 | −0.07796073180093377 |
| a61 | 0.14751387924336015 | a144 | 0.14862796222876595 |
| a62 | −0.061993457194008124 | a145 | 0.3580044925051681 |
| a63 | 0.08586430248304122 | a146 | −0.16854477771456608 |
| a64 | 0.16704850704055443 | a147 | −0.18998185326189743 |
| a65 | 0.07091764628733137 | a148 | 0.29568833942502715 |
| a71 | 0.10415324644013943 | a149 | 0.40500880406992096 |
| a72 | −0.02631417421394259 | a1410 | −0.2922672128367844 |
| a73 | −0.04087529433177786 | a1411 | −0.15880367266753806 |
| a74 | 0.39037577397188017 | a1412 | 0.3016929890600716 |
| a75 | −0.11573352785815892 | a1413 | 0.4050220507945401 |
| a81 | 0.16525173038472643 | | |
| a82 | −0.015500424184182592 | | b: 14-element Array{Float64, 1}: |
| a83 | −0.04970341851251567 | b1 | 0.0020417383068140394 |
| a84 | −0.18632008115387888 | b2 | −0.028528128108588024 |
| a85 | 0.04420661272062375 | b3 | −0.07796073180093377 |
| a86 | 0.4554275503641829 | b4 | 0.14862796222876595 |
| a87 | −0.03728006727074501 | b5 | 0.3580044925051681 |
| a91 | 0.27362109639339016 | b6 | −0.16854477771456608 |
| a92 | −0.010096715159337981 | b7 | −0.18998185326189743 |
| a93 | 0.011606282619919847 | b8 | 0.29568833942502715 |
| a94 | −0.15681076020067763 | b9 | 0.40500880406992096 |
| a95 | −0.21126162831372586 | b10 | −0.2922672128367844 |
| a96 | 0.12844483994757958 | b11 | −0.15880367266753806 |
| a97 | 0.5052692034407622 | b12 | 0.3016929890600716 |
| a101 | 0.04895847627716312 | b13 | 0.4050220507945401 |
| a102 | 0.05549882369147236 | b14 | 0.0 |
| a103 | 0.03371154290450168 | | |
| a104 | 0.02190160196168485 | | c: 14-element Array{Float64, 1}: |
| a105 | 0.004233539425382651 | c1 | 0.0 |
| a106 | 0.03830831741556788 | c2 | 0.022035024212176273 |
| a107 | −0.007800022793209964 | c3 | 0.02183493589050961 |
| a108 | 0.27097241452217663 | c4 | 0.15206330970144885 |
| a109 | 0.20626795775964266 | c5 | 0.08602170049475083 |
| a111 | 0.03761353274951909 | c6 | 0.23762227289419663 |
| a112 | −0.028031232720422364 | c7 | 0.3116060240081402 |
| a113 | −0.04192378872076009 | c8 | 0.37608190234821093 |
| a114 | −0.01181103246843162 | c9 | 0.5407723187279103 |
| a115 | 0.18547421190538863 | c10 | 0.6720526511643818 |
| a116 | 0.27021146786585304 | c11 | 0.6301883494613333 |
| a117 | −0.019097539937169 | c12 | 0.5559779749224847 |
| a118 | 0.0057429749421095 | c13 | 0.8560602864167693 |
| a119 | 0.2320097558452461 | c14 | 1.0 |
| a121 | −0.040236484584306995 | | |
| a122 | 0.00220391728915983 | | and the embedded pair has the ′b′ |
| | | | that is |
| a123 | 0.05301541772368528 | b′1 | −0.0031834403448287715 |
| a124 | 0.01611257442681573 | b′2 | −0.02757697757515617 |
| a125 | 0.07487649225425254 | b′3 | −0.09379794489929281 |
| a126 | 0.20543358183433777 | b′4 | 0.122957577861474 |
| a127 | 0.09193600638823755 | b′5 | 0.3649470206195543 |
| a128 | 0.20401465889577416 | b′6 | −0.07486197783273031 |
| a129 | −0.16970313663025158 | b′7 | −0.09139547129501434 |
| a1210 | 0.1816011564866453 | b′8 | 0.20613618653760052 |
| a1211 | −0.06327620916186488 | b′9 | 0.031921232073918476 |
| a131 | −0.13444291776867823 | b′10 | 0.1410740081421561 |
| a132 | 0.048670268860820806 | b′11 | 0.08983944264284895 |
| a133 | 0.09544838944443924 | b′12 | 0.1505115737647791 |
| a134 | −0.008005093363599084 | b′13 | 0.10065147667215045 |
| a135 | 0.17695715010153226 | b′14 | 0.0827772936325406 |
| a136 | 0.22450760788172397 | | |

In the example 14×14 tableau shown in FIG. 4, there are seven sets of stages, each of which has two operations that are computed simultaneously. In other words, stage 1 is computed. Then stage 2 and stage 3 are computed simultaneously. The zero 402 in stage 3 ensures that stage 3 does not rely on stage 2 and therefore the set of stages 2 and 3 can be computed at the same time. Stage 4 and stage 5 are computed simultaneously. The zero 404 in stage 5 ensures that stage 5 does not rely on stage 4 and therefore the set of stages 4 and 5 can be computed at the same time. The remaining sets of stages are computed in the same manner. The multiple stages that are executed simultaneously as a set are executed using the same operation but with different values (e.g., the values from the tableau or the intermediate values for the calculation).

FIG. 5 depicts an exemplary 14×14 sparsity matrix for a modified Runge-Kutta method according to the subject matter described herein. As with FIG. 4, FIG. 5 shows that the sparsity matrix has a triangular pattern. While traditional Runge-Kutta methods use a sparsity matrix with a lower triangular pattern, the sparsity matrix shown in FIG. 5 includes extra zeroes 502, 504, 506, 508, 510, and 512 in the pattern to allow for the simultaneous calculation of stages k and k+1 for an even stage k.

FIG. 6A depicts a flow chart of an exemplary process for converting a user-provided function into SIMD-compatible operations. At step 600, a user-provided function is received. For example, assume that f(x) computes the force of a spring on a mass when the mass is at location x. This would be represented by Hooke's law f(x)=−k*x, where k is the spring constant (i.e., how stiff the spring is). The user inputs that function, and expects that the simulator calculates f(2) to provide the force when the spring is at 2 cm from the center to the right, and then f(−1) to provide the force when the spring is at 1 cm to the left. These forces are then used to determine how much the mass is accelerating at each time, which allows the next location of the spring to be determined, then the next force, and so on, to complete the simulation process. This process of turning these forces into the simulation is the solving of the ordinary differential equation using the Runge-Kutta method.

As explained herein, this process can be performed faster if the force can be evaluated at two points. Traditional Runge-Kutta methods only allow for the force to be evaluated at one point at a time, whereas the systems and methods described herein provide for a way to take advantage of the hardware architecture to evaluate the force at two points at the same time. Thus, the user provides a function f(x), at step 600, and the systems and methods described herein transform, at step 602, that function f(x), at the compiler level, into a function that evaluates f(x) at two points f(x₁, x₂)=y₁, y₂ that provides the forces f(x₁)=y₁ and f(x₂)=y₂. With a SIMD processor, both of these forces can be computed simultaneously.

More specifically, a user of the solver provides a function to be solved, which is defined as f(x), at step 600. The compiler takes the user-provided function f(x) and transforms each intrinsic operation in the user-provided function f(x) to a SIMD-compatible operation, at step 602. In one embodiment, the transform is performed using the Intel AVX vector instructions. The solver uses the transformed function with the mathematical method.

Thus, the compiler adds in the SIMD instructions. The compiler takes the user-provided function, which is not defined for a SIMD architecture, and automatically constructs the SIMD-compatible form of f(x). This is included in the Julia computing language SIMD.jl package.

Each instruction within the function is converted, at the compiler level, into a function that evaluates at two points. For example, the following function in the Julia computing language converts f(x) into a function that evaluates f(x) at two points f(x₁, x₂)=y₁, y₂ that provides the forces f(x₁)=y₁ and f(x₂)=y₂:

$$function + ( x \text{: :} Float 64 \times 4 , y \text{: :} Float 64 \times 4 ) llvmcall ( ″″″ \% res = fadd \text{<4} \times double > \%0 , \%1 ret \text{<4} \times double > \% res ″″″ , Float 64 \times 4 , Tuple \{ Float 64 \times 4 , Float 64 \times 4 \} , x , y ) end$$

A call to the following instruction on the processor handles four instructions at a time:

$$v 1 = Vec \{ 4 , Float 64 ) ( ( 1 , 2 , 3 , 4 ) )$$

$$v 2 = Vec \{ 4 , Float 64 \} ( ( 10 , 1 \; 00 ) , 1 \_ 000 , 10 \_ 000 ) )$$

$$v 1 + v 2$$

Evaluating f(x) at the multiple points is accomplished by using the following instruction:

$$using SIMD$$

$$f ( x ) = - k * x$$

$$f ( Vec ( x 1 , x 2 ) )$$

$$\# [ - k * x 1 , - k * x 2 ]$$

When the compiler sees an operation inside of the user-provided function, the compiler converts that operation to the SIMD-compatible form, which adapts the user-provided function to be able to evaluate at multiple points simultaneously, which, in turn, adapts the entire user-provided function to be evaluated at multiple points simultaneously. Each internal operation is replaced in a similar fashion.

$$f ( x , y ) = x + y$$

Table 1, below, provides an example of intrinsic functions that can be used to build functions user-provided functions. Each of the functions shown in Table 1 is converted at the compiler level to a SIMD-compatible form. This is done recursively through the entire function definition. Once the entire function is transformed using the above-described replacements, the function can then be executed simultaneously using a SIMD processor architecture.

TABLE 1

| | | | | | |
|---|---|---|---|---|---|
| + | − | * | / | % | \hat{ } |
| ! | ~ | & | \| | $ | << |
| >> | >>> | == | != | < | <= |
| > | >= | abs | cbrt | ceil | copysign |
| Cos | div | exp | exp10 | exp2 | flipsign |
| floor | fma | inv | isfinite | isinf | isnan |
| issubnormal | log | log10 | log2 | muladd | rem |
| round | sign | signbit | sin | sqrt | trunc |
| vifelse | | | | | |

The intrinsic functions shown in Table 1, above, are functions that are specific to the Julia computing language, but it should be understood that the same may be applied for other programming languages as well.

The systems and methods described herein provide a new way of pairing this function transformation with a tableau (e.g., a Runge-Kutta tableau) that has a sparsity matrix amenable to allowing two stages to be computed at the same time, which allows for the function to be used effectively in a simulation context. When these two pieces are applied together, the time to compute N stages of a Runge-Kutta tableau is halved, but missing either piece invalidates that improvement.

Because the present subject matter tunes the Runge-Kutta methods to be executed via the SIMD registers, and given that SIMD registers have fixed sizes (e.g., 128, 256, 512 bits, etc.), the generated parallel Runge-Kutta methods that are specialized to CPU hardware can run multiple k calculations at the same time. These generated parallel Runge-Kutta methods in accordance with the subject matter described herein are referred to as modified Runge-Kutta methods.

Using the registers of the SIMD processor to perform a number of simultaneous k stages includes performing up to as many simultaneous k stages as the bit size or bit length of the SIMD registers allows, or in some embodiments, fewer than the maximum allowed but at least two simultaneous stages. Too many or too few stages compared with the number of SIMD registers (i.e., mismatched software properties and hardware architecture) may decrease the efficiency of the method. By using the registers of the SIMD processor to perform the maximum number of simultaneous k stages, the systems and methods described herein compute significantly more k values without requiring additional compute time, as would be required when using a single-data-based processor. This, in turn, allows the systems and methods described herein to determine more desirable properties of the tableau since there are more numbers to tune (e.g., two, four, or eight times as many), as compared with conventional systems and methods.

FIG. 6B depicts a flow chart of an exemplary process for accelerated solving of ordinary differential equations using Runge-Kutta methods, tuned sparsity patterns, and a SIMD processor architecture according to the subject matter described herein.

Referring to FIG. 6B, at step 630, parallel methods for solving an ODE are generated that are specialized to CPU hardware to run multiple k stages at the same time. In one embodiment, the parallel methods for solving the ODE are Runge-Kutta methods. For example, parallel Runge-Kutta methods may be used to execute the following set of calculations:

$$k 1 = d t * f ( u , t )$$

$$k 2 = d t * f ( u + {a}_{1 , 1} * {k}_{1} , t + {c}_{2} * d t )$$

$$k 3 = d t * f ( u + {a}_{1 , 2} * {k}_{1} , t + {c}_{3} * d t )$$

$$k 4 = d t * f ( u + {a}_{1 , 4} * {k}_{1} + {a}_{2 , 4} * {k}_{2} + {a}_{3 , 4} * {k}_{3} , t + {c}_{4} * d t )$$

$$k 5 = d t * f ( u + {a}_{1 , 5} * {k}_{1} + {a}_{2 , 5} * {k}_{2} + {a}_{3 , 5} * {k}_{3} , t + {c}_{5} * d t )$$

$$…$$

$$kn = d t * f ( u + {a}_{1 , n} * {k}_{1} + … + {a}_{n - 1 , n} {k}_{n - 1} , t + {c}_{n} * d t )$$

$${k}_{n + 1} = d t * f ( u + {a}_{1 , n + 1} * {k}_{1} + … + {a}_{n - 1 , n + 1} {k}_{n - 1} , t + {c}_{n} * d t )$$

The above set of calculations allows for within-method parallelism. This property of the above set of calculations can be represented by a subset of the lower triangular sparsity pattern. The triangular pattern would still allow for a_{2,2} to be non-zero, which is not the case here, and is required to be zero to allow k₃ to be independent of k₂.

The subject matter described herein includes developing and executing methods, including but not limited to Runge-Kutta methods, having this kind of parallel structure. A computing device or compiler can then generate computer-executable software code that includes instructions for a processor having a specific architecture, such as a SIMD processor architecture having known fixed number and size of registers, to perform these parallel calculations of multiple stages at the same time.

To make this implementation automatic, the function is compiled so that the function f can be executed both with inputs u+a_{1,1}*k₁ and u+a_{1,2}*k₁ simultaneously. The same applies to the t argument, but for simplicity we just look at the first. If this cannot be done, then f still needs to be executed two different times. But f in the ordinary differential equation is the model, meaning that f represents the physics given by the user to the program. Therefore, given a user-provided function f, f will be recompiled so that it executes at two simultaneous points. This is described in the context of FIG. 6A.

At step 632, a tableau of coefficients for the generated parallel methods is derived. The derived tableau of coefficients includes a sparsity pattern for the calculations that allow for parallel processing, and the derived coefficients provide optimal or near-optimal processing of the multiple stages of the parallel methods. The derived tableau of coefficients has a sparsity pattern that includes extra zeroes to allow for parallel processing.

At step 634, multiple stages of the parallel methods are run on a SIMD processor to maximize the number of parallel calculations performed per compute time. The derived tableau of coefficients for the particular set of parallel calculations for a particular register size is optimized for that particular set of calculations, which in turn are optimized for the particular register size of the processor on which the modified Runge-Kutta method will be performed.

For example, a Runge-Kutta method for approximating solutions to a differential equation of the form:

y′=f(t,y)

is given by:

$${y}_{n + 1} = {y}_{n} + \frac{h}{6} ( {k}_{n 1} + 2 {k}_{n 2} + 2 {k}_{n 3} + {k}_{n 4} )$$

where the modified Runge-Kutta method can be represented as:

$${k}_{n 1} = f ( {t}_{n} , {y}_{n} )$$

$${k}_{n 2} = f ( {t}_{n} + 0.5 h , {y}_{n} + 0.5 h {k}_{n 1} )$$

$${k}_{n 3} = f ( {t}_{n} + 0.5 h , {y}_{n} + 0.5 h {k}_{n 2} )$$

$${k}_{n 4} = f ( {t}_{n} + h , {y}_{n} + h {k}_{n 3} )$$

The tableau of coefficients for the above modified Runge-Kutta method is as follows and as also shown in FIG. 6E:

$$\text{} \begin{matrix}0 & \vert & & & & \\ 1 / 2 & \vert & 1 / 2 & & & \\ 1 / 2 & \vert & 0 & 1 / 2 & & \\ 1 & \vert & 0 & 0 & 1 & \\ & \vert & 1 / 6 & 1 / 3 & 1 / 3 & 1 / 6\end{matrix}$$

The numbers along the left column (referred to as cᵢ) of the above tableau of coefficients are the coefficients of h in the first argument of f. The numbers along the bottom row (referred to as b;) of the above tableau of coefficients are the coefficients of the ks in the expression for the value of y at the next step. The numbers in the matrix in middle (referred to as a_{i,j}) of the above tableau of coefficients are the coefficients of the ks in the second argument of f. Because this is an explicit method, each stage k only depends on the previous stage ks, and so the tableau of coefficients has a triangular form. This property of the tableau of coefficient is referred to as having a triangular sparsity pattern.

The coefficients for a particular SIMD architecture are pre-derived to optimize for the modified Runge-Kutta methods, and those pre-derived coefficients are multiplied against the data that results from a simulation using the modified Runge-Kutta methods. Thus, a simulation is run at a particular point, and the results from the simulation are then multiplied by the derived coefficients. The results are then used to determine what the simulation will look like in the future.

Different register sizes affect the sparsity matrix in the tableau. In a situation where the modified Runge-Kutta method can perform four operations in parallel from a 256-bit register, the simulation may be tested at four points at a time, as opposed to testing it at a single point in time as would be done in a traditional Runge-Kutta method.

FIG. 6C depicts a flow chart of an exemplary process for performing multiple Runge-Kutta calculations in parallel on a SIMD processor architecture according to the subject matter described herein.

Referring to FIG. 6C, at step 660, a register size of a register of the SIMD hardware processor is determined. The register size may be determined by known methods, for example, by calling a processor function that returns the register size. At step 662, a number of parallel values are loaded into the register for performing the multiple Runge-Kutta calculations. The number of parallel values that are loaded is determined based on the sparsity pattern of the Runge-Kutta tableau. The sparsity pattern of the Runge-Kutta tableau may be smaller than the register size of the register. The maximum number of instructions is equal to the register size divided by a bit size of a floating point representation of the values. In some embodiments, the bit size is 64 bits. In such a scenario, if the register size is 512 bits, then the number of parallel values can be up to 8 (i.e., 8 or fewer). If the register size is 256, the number of parallel values can be up to 4 (i.e., 4 or fewer). If the register size is 128, the number of parallel values can be up to 2 (i.e., 2 or fewer).

At step 664, a set of k stages is run in parallel using the coefficients from a pre-derived tableau of coefficients. The pre-derived tableau of coefficients is a subset of a triangular sparsity pattern that has been predetermined to optimize the multiple k stages running in parallel. The k stages are run in parallel using the register of the SIMD hardware processor. The k stages that are run in parallel are structured such that each stage in the set being run in parallel does not rely on any other stage in that set being run in parallel. The sparsity pattern of the tableau of coefficients is defined such that the k stages that are run in parallel do not rely on any other stage in the set.

FIG. 6D depicts a flow chart of an exemplary process for solving a user-provided function using multiple parallel calculations of an ordinary differential equation solver. At step 680, a user-provided function is received by a compiler. At step 682, each intrinsic operation in the user-provided function is transformed to a SIMD-compatible operation, such that each intrinsic operation can be calculated at multiple points simultaneously. At step 684, an ordinary differential equation is solved using the transformed intrinsic operations by iteratively solving a set of calculations that represents the ordinary differential equation. The set of calculations comprises multiple stages to be executed. At step 686, a number of parallel values is loaded into a register of a SIMD processor to use for parallel calculations. The number of parallel values loaded into the register is equal to or less than the specific register size divided by a bit size of a floating point representation of the values. At step 688, a subset of the multiple stages from the set of calculations is executed in parallel using a pre-derived tableau of coefficients having a sparsity matrix with a lower triangular pattern that includes at least one zero in the pattern to allow for simultaneous calculation of multiple stages using the parallel values. The number of multiple stages from the set of calculations is equal to the number of parallel values loaded into the register. The at least one zero in the pattern of the sparsity matrix is defined such that each stage in the subset of the multiple stages that is executed in parallel does not rely on another stage in the subset of the multiple stages that is executed in parallel.

Thus, according to the subject matter described herein, a standard Runge-Kutta method is rewritten into a modified Runge-Kutta method to allow it to exploit the SIMD register size (e.g., 128-bit, 256-bit, 512-bit, or 1024-bit). Consider the following example. A simulation exists that models the behavior of an object dropped from the sky. The simulation predicts where the object will be in the future after it has been dropped. A Runge-Kutta method may be used in the simulation to determine where the object will be at any given point in time. In traditional Runge-Kutta methods, each calculation will determine where the object will be at a single point in time. Each single-point-in-time calculation is run in series to refine the calculations. In the systems and methods described herein, multiple point-in-time calculations can be run in parallel using the longer registers in combination with the modified Runge-Kutta method that has been rewritten to exploit the longer registers. The modified Runge-Kutta methods described herein determine the optimal time to test the simulation, and the simulation is being tested at multiple places at a time. The numbers chosen for testing the simulation are provided in the tableau. The sparsity pattern of the tableau shows how prior information is used in subsequent calculations.

The specific properties of the sparsity patterns described herein mean that the parallel calculations of the modified Runge-Kutta methods described herein do not rely on each other. By using the sparsity patterns described herein, the modified Runge-Kutta methods have desirable reliance properties. These reliance properties, in turn, use the SIMD architecture to allow for parallel computation of multiple stages of the modified Runge-Kutta methods. The Runge-Kutta tableau coefficients are optimized to include other desired properties, such as high convergence order and low leading truncation errors. The sparsity pattern dictates which coefficients have to be zero, and then the actual values for the non-zero coefficients are determined to optimize these other properties. In other words, the matrix is “sparsified” in a specific way that allows for beneficial application of the Runge-Kutta method.

The systems and methods described herein have been tested using various well-known testing problems from a paper providing test suites, available at https://dl.acm.org/doi/pdf/10.1145/23002.27645. These testing problems provide routines for testing ordinary differential equation initial value methods with nonlinear coupling. Work-precision diagrams for the various well-known testing problems are shown in FIGS. 7-12. In FIGS. 7-12, the y-axis is the runtime, and the x-axis is the error of the approximation. The lower the curve appears on the diagrams, the better performance of the system. The MER5v2 line shown in FIGS. 7-12 represents the results obtained using the systems and methods described herein. MER5v2 is a 5^{th}-order explicit Runge-Kutta method suitable for 2-SIMD architectures (i.e., single-instruction, two-data). DP5, Tsit5, and Vern6 are currently the most commonly used classical explicit RK methods. As can be seen from the results shown in FIGS. 7-12, the MER5v2 using the systems and methods described herein performed better than the commonly used classical explicit RK methods. FIGS. 7-12 show that, given the same accuracy requirement, for problems C2 to C5, MER5v2 is consistently two times faster than the other, traditional methods.

FIG. 7 depicts results C1 from running a first well-known testing problem using the systems and methods described herein, as compared to other known systems and methods for solving ordinary differential equations. The first testing problem is as follows:

$$\begin{matrix}{y}_{1}^{′} = - {y}_{1} + {y}_{2}^{2} + {y}_{3}^{2} + {y}_{4}^{2} & {y}_{1} ( 0 ) = 1 \\ {y}_{2}^{′} = - 10 {y}_{2} + 10 ( {y}_{3}^{2} + {y}_{4}^{2} ) & {y}_{2} ( 0 ) = 1 \\ {y}_{3}^{′} = - 40 {y}_{3} + 40 {y}_{4}^{2} & {y}_{3} ( 0 ) = 1 \\ {y}_{4}^{′} = - 100 {y}_{4} + 2 & {y}_{4} ( 0 ) = 1\end{matrix} \\ \begin{matrix}{x}_{f} = 20 & {h}_{0} = 1 {0}^{- 2}\end{matrix}$$

Referring to FIG. 7, line 702 depicts the DP5 results for the first testing problem, line 704 depicts the Tsit5 results for the first testing problem, line 706 depicts the MER5v2 results for the first testing problem, and line 708 depicts the Vern6 results for the first testing problem. As can be seen from line 706, the MER5v2 results performed better than the others.

FIG. 8 depicts results C2 from running a second well-known testing problem using the systems and methods described herein, as compared to other known systems and methods for solving ordinary differential equations. The second testing problem is as follows:

$$\begin{matrix}{y}_{1}^{′} = - {y}_{1} + 2 & {y}_{1} ( 0 ) = 1 \\ {y}_{2}^{′} = - 10 {y}_{2} + β {y}_{1}^{2} & {y}_{2} ( 0 ) = 1 \\ {y}_{3}^{′} = - 40 {y}_{3} + 4 β ( {y}_{1}^{2} + {y}_{2}^{2} ) & {y}_{3} ( 0 ) = 1 \\ {y}_{4}^{′} = - 100 {y}_{4} + 10 β ( {y}_{1}^{2} + {y}_{2}^{2} + {y}_{3}^{2} ) & {y}_{4} ( 0 ) = 1\end{matrix} \\ \begin{matrix}β = 0.1 & {x}_{f} = 20 & {h}^{0} = 1 {0}^{- 2}\end{matrix}$$

Referring to FIG. 8, line 802 depicts the DP5 results for the second testing problem, line 804 depicts the Tsit5 results for the second testing problem, and line 806 depicts the MER5v2 results for the second testing problem. As can be seen from line 806, the MER5v2 results performed better than the others.

FIG. 9 depicts results C3 from running a third well-known testing problem using the systems and methods described herein, as compared to other known systems and methods for solving ordinary differential equations. The third testing problem is as follows:

$$\begin{matrix}{y}_{1}^{′} = - {y}_{1} + 2 & {y}_{1} ( 0 ) = 1 \\ {y}_{2}^{′} = - 10 {y}_{2} + β {y}_{1}^{2} & {y}_{2} ( 0 ) = 1 \\ {y}_{3}^{′} = - 40 {y}_{3} + 4 β ( {y}_{1}^{2} + {y}_{2}^{2} ) & {y}_{3} ( 0 ) = 1 \\ {y}_{4}^{′} = - 100 {y}_{4} + 10 β ( {y}_{1}^{2} + {y}_{2}^{2} + {y}_{3}^{2} ) & {y}_{4} ( 0 ) = 1\end{matrix} \\ \begin{matrix}β = 1 & {x}_{f} = 20 & {h}^{0} = 1 {0}^{- 2}\end{matrix}$$

Referring to FIG. 9, line 902 depicts the DP5 results for the third testing problem, line 904 depicts the Tsit5 results for the third testing problem, and line 906 depicts the MER5v2 results for the third testing problem. As can be seen from line 906, the MER5v2 results performed better than the others.

FIG. 10 depicts results C4 from running a fourth well-known testing problem using the systems and methods described herein, as compared to other known systems and methods for solving ordinary differential equations. The fourth testing problem is as follows:

$$\begin{matrix}{y}_{1}^{′} = - {y}_{1} + 2 & {y}_{1} ( 0 ) = 1 \\ {y}_{2}^{′} = - 10 {y}_{2} + β {y}_{1}^{2} & {y}_{2} ( 0 ) = 1 \\ {y}_{3}^{′} = - 40 {y}_{3} + 4 β ( {y}_{1}^{2} + {y}_{2}^{2} ) & {y}_{3} ( 0 ) = 1 \\ {y}_{4}^{′} = - 100 {y}_{4} + 10 β ( {y}_{1}^{2} + {y}_{2}^{2} + {y}_{3}^{2} ) & {y}_{4} ( 0 ) = 1\end{matrix} \\ \begin{matrix}β = 10 & {x}_{f} = 20 & {h}^{0} = 1 {0}^{- 2}\end{matrix}$$

Referring to FIG. 10, line 1002 depicts the DP5 results for the fourth testing problem, line 1004 depicts the Tsit5 results for the fourth testing problem, and line 1006 depicts the MER5v2 results for the fourth testing problem. As can be seen from line 1006, the MER5v2 results performed better than the others.

FIG. 11 depicts results C5 from running a fifth well-known testing problem using the systems and methods described herein, as compared to other known systems and methods for solving ordinary differential equations. The fifth testing problem is as follows:

$$\begin{matrix}{y}_{1}^{′} = - {y}_{1} + 2 & {y}_{1} ( 0 ) = 1 \\ {y}_{2}^{′} = - 10 {y}_{2} + β {y}_{1}^{2} & {y}_{2} ( 0 ) = 1 \\ {y}_{3}^{′} = - 40 {y}_{3} + 4 β ( {y}_{1}^{2} + {y}_{2}^{2} ) & {y}_{3} ( 0 ) = 1 \\ {y}_{4}^{′} = - 100 {y}_{4} + 10 β ( {y}_{1}^{2} + {y}_{2}^{2} + {y}_{3}^{2} ) & {y}_{4} ( 0 ) = 1\end{matrix} \\ \begin{matrix}β = 20 & {x}_{f} = 20 & {h}^{0} = 1 {0}^{- 2}\end{matrix}$$

Referring to FIG. 11, line 1102 depicts the DP5 results for the fifth testing problem, line 1104 depicts the Tsit5 results for the fifth testing problem, and line 1106 depicts the MER5v2 results for the fifth testing problem. As can be seen from line 1106, the MER5v2 results performed better than the others.

FIG. 12 depicts results NC5 from running a sixth well-known testing problem using the systems and methods described herein, as compared to other known systems and methods for solving ordinary differential equations. The sixth testing problem approximates motion of five outer planets about the sun. The three spatial coordinates of the jth body are y₁ⱼ, y₂ⱼ, y₃ⱼ, and j=1, 2, . . . , 5. Each of the 15 coordinates satisfies a second-order differential equation:

$${y}_{i j}^{″} = {k}_{2} ( \frac{- ( {m}_{0} + {m}_{j} ) {y}_{i j}}{{r}_{j}^{3}} {{\sum }_{k = 1}^{5}}_{k \neq j} {m}_{k} [ \frac{{y}_{i k} - {y}_{i j}}{{d}_{j k}^{3}} - \frac{{y}_{i k}}{{r}_{k}^{3}} ] )$$

$$where$$

$${r}_{j}^{2} = {\sum }_{i = 1}^{3} {y}_{i j}^{2}$$

$$and$$

$${d}_{k j}^{2} = {\sum }_{i = 1}^{3} {( {y}_{k} - {y}_{i j} )}^{2} , \qquad k , j = 1 , … , 5.$$

When this system is rewritten using only first-order differential equations, the dependent vector has 30 components, as follows:
K₂=2,95912208286 (gravitational constant)
m₀=1.00000597682 (mass of the sun and the four inner planets)
m₁=0.000954786104043 (Jupiter)
m₂0.000285583733151 (Saturn)
m₃=0.0000437273164546 (Uranus)
m₄=0.00000517759138449 (Neptune)
m₅=0.0000027777777778 (Pluto)

$$\begin{matrix}{y}_{11} = 3.42947415 \; 189 & {y}_{11}^{′} = - 0.557160570446 \\ {y}_{21} = 3.35386959 \; 711 & {y}_{21}^{′} = 0.505695783289 \\ {y}_{31} = 1.3594901 \; 715 & {y}_{31}^{′} = 0.230578543901 \\ {y}_{12} = 6.64145542 \; 550 & {y}_{12}^{′} = - 0.415570776342 \\ {y}_{22} = 5.97156957 \; 878 & {y}_{22}^{′} = 0.365682722812 \\ {y}_{32} = 2.18231499 \; 728 & {y}_{32}^{′} = 0.169143213293 \\ {y}_{13} = 11.2630437 \; 207 & {y}_{13}^{′} = - 0.325325669158 \\ {y}_{23} = 14.6952576 \; 794 & {y}_{23}^{′} = 0.189706021964 \\ {y}_{33} = 6.27960525 \; 067 & {y}_{33}^{′} = 0.087726532278 \\ {y}_{14} = - 30.1552268 \; 759 & {y}_{14}^{′} = - 0.0240476254170 \\ {y}_{24} = 1.65699966 \; 404 & {y}_{24}^{′} = - 0.287659532608 \\ {y}_{34} = 1.43785752 \; 721 & {y}_{34}^{′} = - 0.117219543175 \\ {y}_{15} = - 21.1238353 \; 380 & {y}_{15}^{′} = - 0.176860753121 \\ {y}_{25} = 28.4465098 \; 142 & {y}_{25}^{′} = - 0.216393453025 \\ {y}_{35} = 15.3882659 \; 679 & {y}_{35}^{′} = - 0.0148647893090\end{matrix} \\ {x}_{f} = 20$$

Referring to FIG. 12, line 1202 depicts the DP5 results for the sixth testing problem, line 1204 depicts the Tsit5 results for the sixth testing problem, and line 1206 depicts the MER5v2 results for the sixth testing problem. As can be seen from line 1206, the MER5v2 results performed better than the others.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance-including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

1. A system for solving a user-provided function using multiple parallel calculations of an ordinary differential equation solver, the system comprising:
a compiler; and
a single-instruction, multiple-data (SIMD) hardware processor architecture comprising:
a register having a specific register size; and
a vector processing unit;
wherein the compiler is configured for:
receiving a user-provided function;
transforming each intrinsic operation in the user-provided function to a SIMD-compatible operation, such that each intrinsic operation can be calculated at multiple points simultaneously; and
wherein the vector processing unit is configured for:
solving an ordinary differential equation using the transformed intrinsic operations by iteratively solving a set of calculations that represents the ordinary differential equation, wherein the set of calculations comprises multiple stages to be executed;
loading a number of parallel values into the register to use for parallel calculations, wherein the number of parallel values loaded into the register is equal to or less than the specific register size divided by a bit size of a floating point representation of the values; and
executing in parallel a subset of the multiple stages from the set of calculations using a pre-derived tableau of coefficients having a sparsity matrix with a lower triangular pattern that includes at least one zero in the pattern to allow for simultaneous calculation of multiple stages using the parallel values, wherein the number of multiple stages from the set of calculations is equal to the number of parallel values loaded into the register;
wherein the at least one zero in the pattern of the sparsity matrix is defined such that each stage in the subset of the multiple stages that is executed in parallel does not rely on another stage in the subset of the multiple stages that is executed in parallel.

2. The system of claim 1, wherein the intrinsic operations are transformed to the SIMD-compatible operations using Intel SSE instructions.

3. The system of claim 1, wherein the set of calculations includes 14 calculations.

4. The system of claim 3, wherein the subset of multiple stages includes two stages, such that the set of 14 calculations is solved using 7 sets of two stages that are executed in parallel.

5. The system of claim 1, wherein the parallel values loaded into the register are coefficients from the pre-derived tableau of coefficients or are intermediate values that are determined during execution of the subset of multiple stages from the set of calculations.

6. The system of claim 1, wherein the tableau-based method of solving the ordinary differential equation is a Runge-Kutta method.

7. The system of claim 1, wherein the register size is 128 bits and the number of parallel values is two.

8. The system of claim 1, wherein the register size is 256 bits and the number of parallel values is two or four.

9. A system for performing multiple parallel calculations of a tableau-based ordinary differential equation solver, the system comprising:
a single-instruction, multiple-data (SIMD) hardware processor architecture comprising:
a register having a specific register size; and
a processor;
wherein the processor is configured for:
solving an ordinary differential equation by iteratively solving a set of calculations that represents the ordinary differential equation, wherein the set of calculations comprises multiple stages to be executed;
loading a number of parallel values into the register to use for the multiple parallel calculations, wherein the number of parallel values loaded into the register is equal to or less than the specific register size divided by a bit size of a floating point representation of the values; and
executing a subset of the multiple stages from the set of calculations in parallel using a pre-derived tableau of coefficients having a sparsity matrix with a lower triangular pattern that includes at least one zero in the pattern to allow for simultaneous calculation of multiple stages using the parallel values, wherein the number of multiple stages from the set of calculations is equal to the number of parallel values loaded into the register;
wherein the at least one zero in the pattern of the sparsity matrix is defined such that each stage in the subset of the multiple stages that is executed in parallel does not rely on another stage in the subset of the multiple stages that is executed in parallel.

10. The system of claim 9, wherein the set of calculations includes 14 calculations.

11. The system of claim 10, wherein the subset of multiple stages includes two stages, such that the set of 14 calculations is solved using 7 sets of two stages that are executed in parallel.

12. The system of claim 9, wherein the processor is a central processing unit (CPU) or a graphics processing unit (GPU).

13. The system of claim 9, wherein the values loaded into the register are coefficients from the pre-derived tableau of coefficients.

14. The system of claim 9, wherein the values loaded into the register are intermediate values that are determined during execution of the subset of multiple stages from the set of calculations.

15. The system of claim 9, wherein the register size is 128 bits and the number of parallel values is two.

16. The system of claim 9, wherein the register size is 256 bits and the number of parallel values is two or four.

17. A method for performing multiple parallel calculations of a tableau-based method of solving an ordinary differential equation on a single-instruction, multiple-data (SIMD) hardware processor architecture, the method comprising:
solving an ordinary differential equation by iteratively solving a set of calculations that represents the ordinary differential equation, wherein the set of calculations comprises multiple stages to be executed;
loading a number of parallel values into a register of the SIMD hardware processor to use for the multiple parallel calculations, wherein the number of parallel values loaded into the register of the SIMD hardware processor is equal to or less than a size of the register divided by a bit size of a floating point representation of the values; and
executing a subset of the multiple stages from the set of calculations in parallel using a pre-derived tableau of coefficients having a sparsity matrix with a lower triangular pattern that includes at least one zero in the pattern to allow for simultaneous calculation of multiple stages using the parallel values, wherein the number of multiple stages from the set of calculations is equal to the number of parallel values loaded into the register;
wherein the at least one zero in the pattern of the sparsity matrix is defined such that each stage in the subset of the multiple stages that is executed in parallel does not rely on another stage in the subset of the multiple stages that is executed in parallel.

18. The method of claim 17, further comprising determining the register size of the register of the SIMD hardware processor using a standard instruction.

19. The method of claim 17, wherein the tableau-based method of solving the ordinary differential equation is a Runge-Kutta method.

20. The method of claim 17, wherein the register size is 128 bits and the number of parallel values is two, or the register size is 256 bits and the number of parallel values is two or four.
